(19) United States
(12) Patent Application Publication
(10) Pub. No.: US 2005/0204621 A1
(43) Pub. Date: Sep. 22, 2005

(54) Panelized planter box system and method of forming same

(76) Inventor: James G. Garrison, Kalamazoo, MI (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 11/083,875

(22) Filed: Mar. 18, 2005

Related U.S. Application Data
(60) Provisional application No. 60/554,294, filed on Mar. 18, 2004.

(51) Int. Cl. A01G 9/02

(52) U.S. Cl. 47/66.1

(57) ABSTRACT

A panelized planter box system (10) and method which includes an upper rail (12), lower rail (14) and a group of sized side panels (16, 18) that are arranged to fit within the upper rail (12) and the lower rail (14). A group of rail corner brackets (30) is used for fastening corners of the lower rail (14) into a fixed position. The invention provides that the lower rail (14) is configured to deflect moisture from within the planter box. The invention may be customized into any number of configurations to give a clean and professional appearance in landscape architectural design projects.

### RELATED APPLICATIONS

Priority for this application is based on U.S. Provisional patent application Ser. No. 60/554,294 filed Mar. 18, 2004, entitled Panelized Planter Box System.

### FIELD OF THE INVENTION

The present invention relates to a planter box and more particularly to panels and associated upper and lower rails used to form a planter box system.

### BACKGROUND

Planter boxes are well known in the art and are typically used to contain plants, shrubs and other vegetation for landscape architectural applications. Most concrete planter boxes are pre-cast into standard sizes and shapes. Other types of concrete planter boxes are formed and cast on site during the construction process. Although these types of planter boxes allow for the design of custom sizes and shapes, they are expensive to manufacture and have a number of disadvantages. For example, the custom on-site type of planter boxes only have a limited number of design options available to the landscape designer which limit the overall design flexibility and types of applications available. Additionally, the prior art planter boxes such as that shown by U.S. Pat. No. 6,625,944, which is herein incorporated by reference, shows the use of panels used with joining or framing members. Systems of this type are not securely fastened together to support the weight of large trees and shrubs. Additionally, boxes of this type may only be used in light-duty applications, where the size and weight of both the plants and the manufacturing materials are not a factor. Accordingly, there is a need for a planter box system that fills the gap between the standard precast planter box and the expensive custom cast on-site planter box.

### SUMMARY OF THE INVENTION

The present invention discloses a panelized planter box system that allows for on-site assembly of almost any size and shape planter box. The planter box is constructed using a number of preformed metallic upper and lower rails. These rails work to securely hold several preformed panels that outline the walls of the planter box. The shape of the rails allows the planter box to offer a number of distinct advantages over prior art designs including drainage, structural integrity, and material preservation. The rails can be manufactured according to the size and shape of the desired planter box. In addition to its use with plants, seating benches can be mounted on an assembled planter box allowing it to be configured in a variety of ways.

### DESCRIPTION OF DRAWINGS

FIG. 1 is a perspective view of the invention showing a typical 2 ft.×5 ft. planter box.

FIG. 2 is a perspective view of panels used in accordance with the invention.

FIG. 3 is a perspective view of the upper and lower rails used in accordance with the invention.

FIG. 4 is a close-up perspective view of the tie-down strap used with the present invention.

FIG. 5 is an exploded view of the planter box used in the present invention.

FIG. 6 is a perspective view of a lower rail corner bracket as used in the present invention.

FIG. 7 is a close-up plan view illustrating the usage and position of a lower rail corner bracket in accordance with the present invention.

FIG. 8 is a plan view illustrating the position of a lower rail corner bracket on an assembled lower rail in accordance with the present invention.

FIG. 9 is a perspective view of an upper rail corner bracket in accordance with the invention.

FIG. 10 is a perspective view illustrating the fabrication of an upper rail tab in accordance with the invention.

FIG. 11 is a perspective view illustrating the interaction of panels, the upper rail tab, and the upper rail corner bracket in accordance with the invention.

FIG. 12 is an elevated perspective view illustrating the interaction of a modified upper rail corner bracket and side panel in accordance with the present invention.

### DESCRIPTION OF THE PREFERRED EMBODIMENT

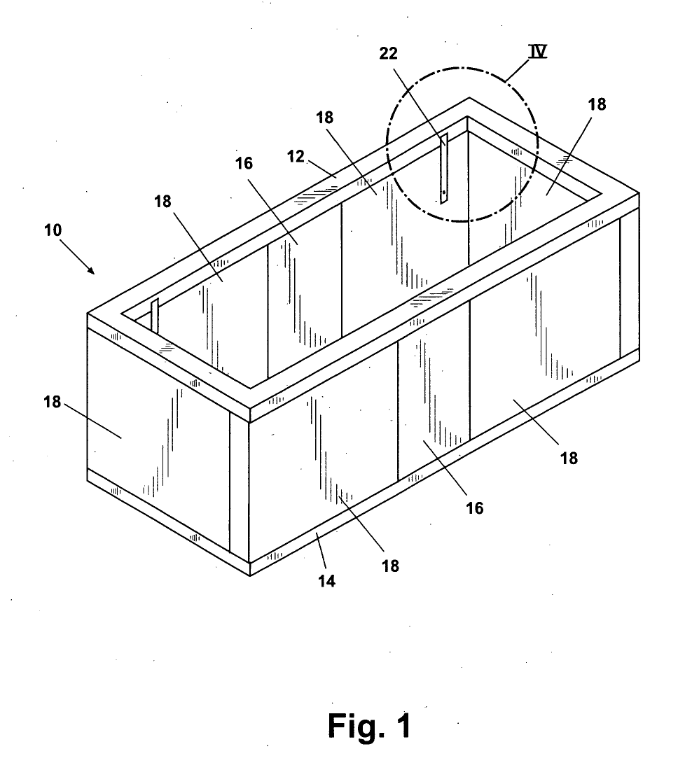

FIG. 1 illustrates an elevated perspective view of an assembled two-by-five-foot rectangular planter box 10 in accordance with the present invention. The lower rail 14 is on the bottom portion of the planter box and provides inward force on the bottom edge of the side panels 16, 18. Similarly, an upper rail 12 rests on the upper edge of the panels 16, 18 and provides an inward force to the side panels. This view also shows the position of a tie-down strap 22 that works to hold the upper rail 12 to the side panels 16, 18 and is discussed in more detail herein. Those skilled in the art will recognize that although the planter box 10 as shown in FIG. 1 is a simple rectangle, the planter box of the present invention may be configured in any type of straight geometric arrangement. Once assembled, soil and plant retention is accomplished by lining the planter box 10 with a silt impermeable fabric material or the like (not shown). The fabric material acts to prevent the escape of planting materials from under the side panels 16, 18 while still allowing water to escape through spaces or the open bottom into the ground.

FIG. 2 illustrates a perspective view of the type of wall panels 16 and 18 as used for the walls of the planter box 10 shown in FIG. 1. Also shown is a larger panel 20 that may be used depending on the size and shape of the desired planter box. Each of the panels 16, 18, 20 may be typically manufactured of stone, concrete or similar rigid materials which are manufactured offsite in predetermined dimensions to allow for any required shape or size variations in the planter box configuration. Typically, the thickness of a panel is approximately three inches but may vary according to any desired application.

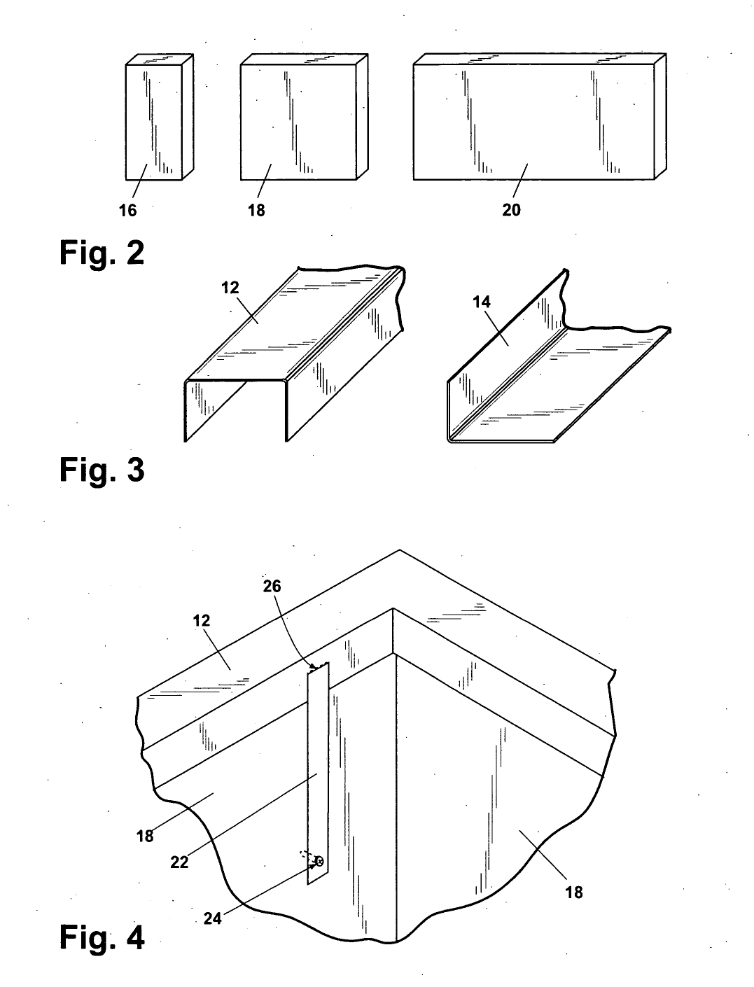

FIG. 3 shows cross sections of the upper rail 12 and the lower rail 14. Both the upper rail 12 and the lower rail 14 may be manufactured of sheet metal or similar materials and typically have a thickness of approximately 1/8 inch. The upper rail 12 has a “U” cross-sectional shape to hold a panel between its two side edges or tabs of the rail. The lower rail 14 has an “L” cross-sectional shape which allows rain water or other moisture to drain away from a lower edge of the panel. By moving moisture away from the rails, this shape works to prevent deterioration or rot of the materials used in the manufacture of the planter box. Those skilled in the art will recognize that this is an important advantage in freezing climates since water cannot pool and freeze in the lower rail of the panel's bottom edge. Any freezing moisture can ultimately cause breakage and failure of the overall structural integrity of the planter box 10. As should be further evident to those skilled in the art, the rails 12, 14 may be cut and welded according to any desired shape of the planter box. Although straight line geometric patterns are preferred, any geometric pattern may be within the scope of the invention.

FIG. 4 shows a close-up view illustrating the placement and usage of a tie-down strap 22. The tie-down strap 22 is typically manufactured of metal and includes a fastener hole 24 at one end. The strap 22 typically is welded 26 to the upper rail 12 as shown to reduce the chance of strap failure. In order to fasten the strap 22, a fastening screw or other type of fastener passes through the hole 24 and into the panel 18. In practice, the tie-down strap 22 is used to prevent the upper rail 12 from being lifted off the panels, keeping them in a tightly locked configuration.

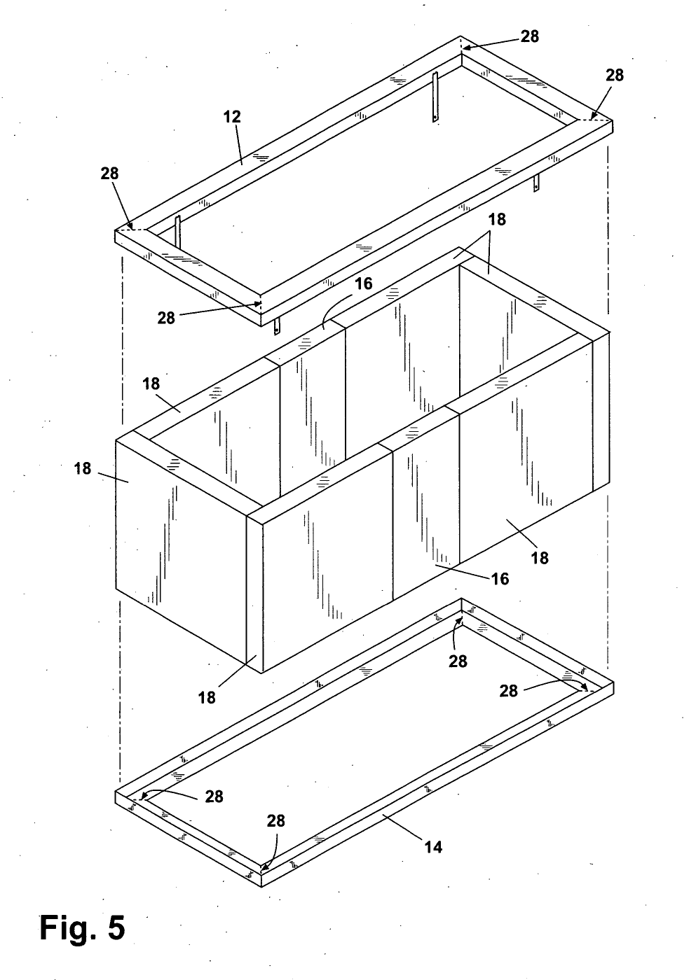

FIG. 5 is an exploded view of the two-by-five-foot rectangular planter box as shown in FIG. 1. This view shows the upper rail 12 and lower rail 14 after they have been cut and welded 28 into the appropriate shape for this planter box. This figure illustrates how the panels 16, 18 are arranged to form a planter box into a rectangular configuration. Since this is a relatively small planter box, as compared to boxes having many more panels, the larger panel 20 as shown in FIG. 2 is not used.

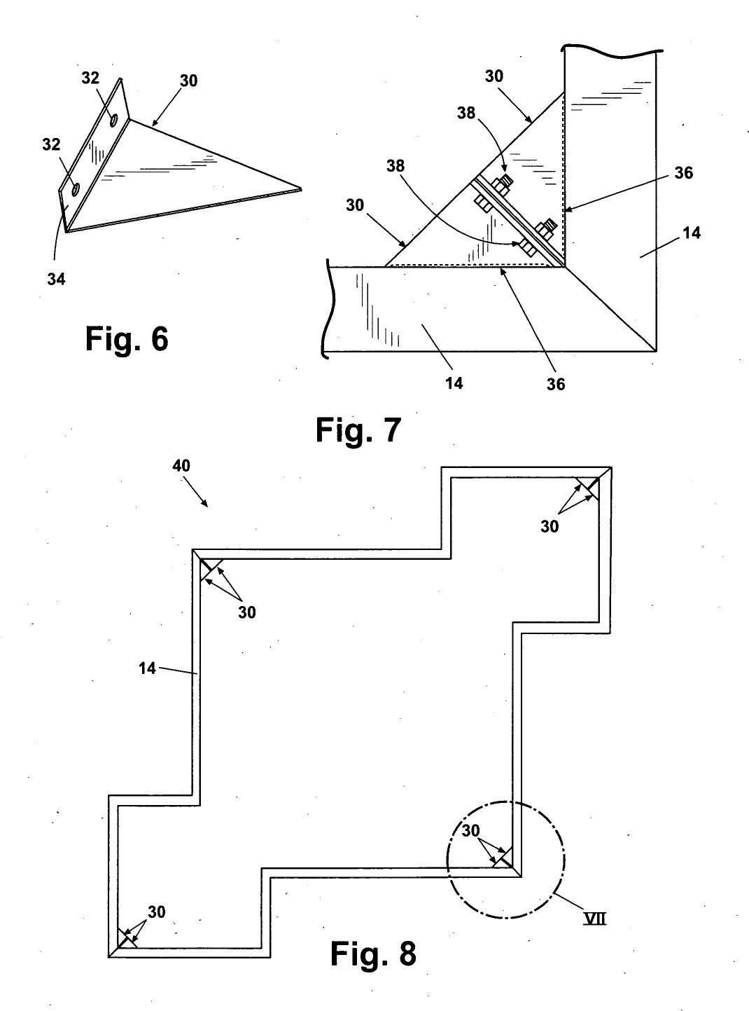

FIG. 6 shows a lower rail corner bracket 30. The lower rail corner bracket 30 is a substantially triangular configuration with holes 32 in its vertical element 34. The bracket 30 is typically manufactured of sheet metal having a thickness of approximately 1/8 inch and is used in connection with the lower rail 14 to securely fasten each rail into a rigid position.

FIG. 7 is a perspective view of a plurality of corner brackets 30 where the lower rails 14 are positioned in joining right angles. Those skilled in the art will recognize that the corner brackets 30 are welded 36 onto the lower rail 14 and used with fastening bolts 38. The fastening bolts 38 are used with holes 32 to securely hold the two lower rail sections in a rigid and fixed position.

FIG. 8 illustrates a top plan view of a large planter box 40 using an assembled lower rail 14 and lower rail corner brackets 30. It will be further recognized that when planter box dimensions exceed shipping dimensions, corner brackets 30 must be used to allow for shipping and on-site assembly. In some situations, when the planter box 40 is oriented into substantially large configuration, the upper rails 32 may require a unique mounting bracket as described herein.

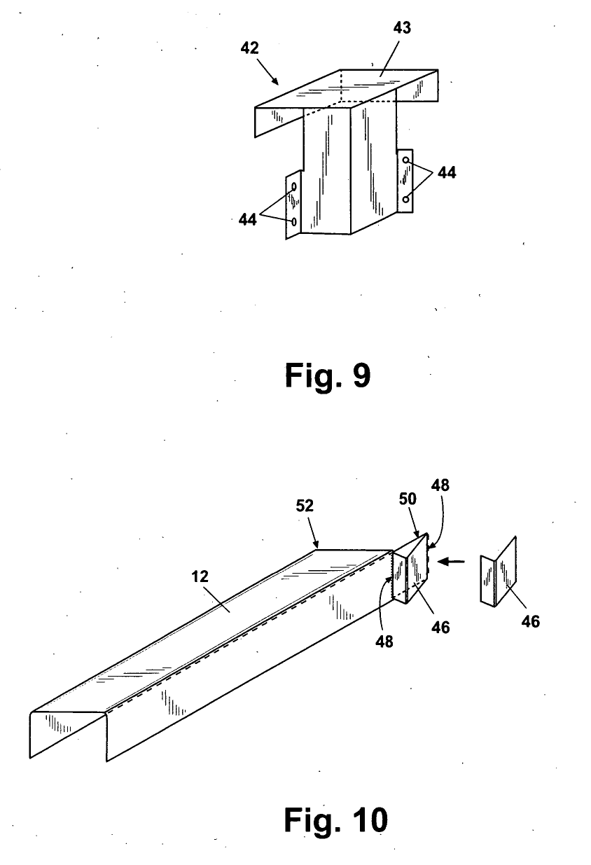

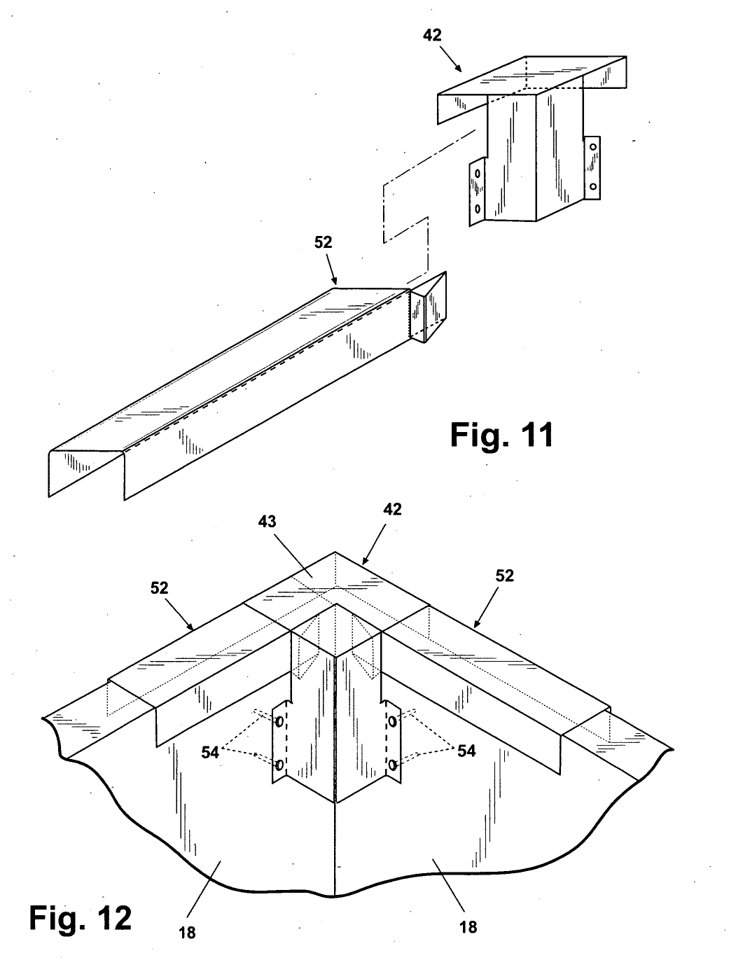

FIGS. 9-11 illustrate an upper rail corner bracket 42 used for large and complex planter box configurations. The upper rail corner bracket 42 is typically manufactured of sheet metal having a thickness of approximately 1/8 inch and includes a top hat section 43 and one or more fastener holes 44. FIG. 10 shows the modifications that must be made to an upper rail section 12 in order for it to fit into an upper rail corner bracket 42. The upper rail 12 must have a portion equaling approximately two inches of its top and outer sides removed. A metallic tab 46 that takes the form of a triangular wedge is welded 48 to an extended side 50 of the upper rail 12. These modifications form an upper rail section 52 that is capable of being used with the upper rail corner bracket 42. Finally, FIG. 11 illustrates the interaction of a modified upper rail section 52 with the upper rail corner bracket 42 where the outer edge of the modified upper rail section is positioned behind the upper rail corner bracket 42.

FIG. 12 shows the interaction of modified upper rails 52, an upper rail corner bracket 42, and panels 18. The modified upper rails are placed on the top edge of the panels 18 as shown. The upper rail corner bracket 42 is then placed with its top hat section 43 on the top edge of the panels 18. By using the upper rail bracket 42, the metallic tabs 46 of the modified upper rails 12 are now forceably restrained under the upper rail corner bracket 42 wherever a corner is assembled. The upper rail corner bracket 42 can then be secured to the panels 18 using screws 54 or other type fasteners. The use of the upper rail corner bracket 42 allows a large planter box be secured into a much more rigid structure allowing it to hold large amounts of soil and plant material to prevent panel wall separation.

To summarize, the planter box system of the present invention allows for design flexibility without excessive cost. A landscape designer may send a drawing of the desired planter box, and the drawing can be used to determine the dimensions of the upper and lower rails 12, 14. The rails would then be manufactured, and the necessary number of panels 16, 18, 20 selected. These elements would then be shipped to the job site where the planter box system would then be assembled. In an alternative embodiment, a bench or the like could then be attached to the panels if desired. The planter box is then filled with soil and plant material for a unique customized appearance.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A panelized planter box system comprising:
at least one upper rail;
at least one lower rail;
a plurality of side panels arranged to fit within the at least one upper rail and the at least one lower rail;
a plurality of lower rail corner brackets for fastening corners of the at least one lower rail into a fixed position; and
wherein the at least one lower rail is configured to deflect moisture from within the planter box.

2. A panelized planter box system as in claim 1, further comprising:
at least one tie-down strap for securing the at least one upper rail to the plurality of side panels.

3. A panelized planter box system as in claim 1, wherein the plurality of upper rails have a U-shaped cross section for securely holding an upper portion of the plurality of side panels.

4. A panelized planter box system as in claim 1, wherein the plurality of lower rails have an L-shaped cross section for securely holding a lower portion of the plurality of side panels.

5. A panelized planter box system as in claim 1, further comprising a plurality of upper rail corner brackets for fastening corners of at least one upper rail and the plurality of side panels into a fixed position.

6. A panelized planter box system as in claim 5, wherein the plurality of upper rail corner brackets include a top hat section for mounting over the at least one upper rail.

7. A panelized planter box system as in claim 5, wherein the plurality of upper rail corner brackets securely hold a tab section attached to a portion of the at least one upper rail.

8. A panelized planter box system as in claim 1, wherein each one of the plurality of low rail corner brackets includes maybe to fastening to one another along a common edge.

9. A panelized planter box system for configuring a planter box into a customized shape comprising:
a plurality of upper rail sections used to form an upper rail;
a plurality of lower rail sections used to form a lower rail;
a plurality of panels that are secured between the upper rail and lower rail to form a planter box;
at least one tie-down strap fastened between the upper rail and at least one of the plurality of panels; and
wherein the lower rail is configured to deflect moisture from within the planter box.

10. A paneled planter box system as in claim 9, wherein the upper rail has a U-shaped cross section for fastening an upper portion of the plurality of panels.

11. A paneled planter box system as in claim 9, wherein the lower rail has an L-shaped cross section for securely fastening a lower portion of the plurality of panels.

12. A paneled planter box system as in claim 9, further comprising:
a plurality of triangular corner brackets integrally fastened to the lower rail for fastening to another one of the plurality of triangular corner brackets for rigidly fastening the lower rail into a secure position.

13. A paneled planter box system as in claim 9, further comprising an upper rail corner bracket for rigidly fastening the upper rail into a secure position.

14. A method for constructing a panelized planter box system comprising the steps of:
forming at least one upper rail;
forming at least one lower rail;
inserting a plurality of side panels between the at least one upper rail and the at least one lower rail to form a planter box;
fastening corners of the at least one lower rail into a fixed position using corner rail brackets; and
configuring the at least one lower rail to deflect moisture from within the planter box.

15. A method for constructing a panelized planter box system as in claim 14, further comprising the step of:
securing the at least one upper rail to the plurality of side panels using a tie-down strap.

16. A method for constructing a panelized planter box system as in claim 14, further comprising the step of:
forming the plurality of upper rails into a U-shaped cross section for securely holding an upper portion of the plurality of side panels.

17. A method for constructing a panelized planter box system as in claim 14, further comprising the step of:
forming the plurality of lower rails into an L-shaped cross section for securely holding a lower portion of the plurality of side panels.

18. A method for constructing a panelized planter box system as in claim 14, further comprising the step of:
utilizing an integrally fastened rail corner bracket with each one of the plurality of side panels.

19. A method for constructing a panelized planter box system as in claim 14, further comprising the step of:
forming each one of the plurality of rail corner brackets into substantially triangular shape for fastening to one another along a common edge.

20. A method for constructing a panelized planter box system as in claim 14, further comprising the step of:
forming each one of the plurality of rail corner brackets so as to forceably secure a tab attached to a section of the at least one upper rail.
